(19) United States
(12) Patent Application Publication
(10) Pub. No.: US 2018/0034029 A1
(43) Pub. Date: Feb. 1, 2018

(54) COMPOSITE SEPARATOR AND PREPARATION METHOD THEREFOR, AND LITHIUM-ION BATTERY

(71) Applicants: Jiangsu Huadong Institute of Li-Ion Battery Co., Ltd., Suzhou (CN); Tsinghua University, Beijing (CN)

(72) Inventors: YU-MING SHANG, Beijing (CN); XIAO-LEI DING, Beijing (CN); XIANG-MING HE, Beijing (CN); LI WANG, Beijing (CN); JIAN-JUN LI, Beijing (CN); YAO-WU WANG, Beijing (CN); JIAN GAO, Beijing (CN)

(73) Assignees: Jiangsu Huadong Institute of Li-Ion Battery Co., Ltd., Suzhou (CN); Tsinghua University, Beijing (CN)

(21) Appl. No.: 15/726,385

(22) Filed: Oct. 6, 2017

Related U.S. Application Data
(63) Continuation of application No. PCT/CN2016/078395, filed on Apr. 1, 2016.

(30) Foreign Application Priority Data
Apr. 9, 2015 (CN) 201510163908.9

(51) Int. Cl. H01M 2/16; H01M 10/0565; H01M 2/14; H01M 10/0525

(52) U.S. Cl. CPC H01M 2/1653; H01M 10/0525; H01M 10/0565; H01M 2/145

(57) ABSTRACT

A composite separator is disclosed. The composite separator includes a base membrane, and a composite gel composited with the base membrane. The composite gel includes a gel polymer and a nano-barium sulfate dispersed in the gel polymer. A surface of the nano-barium sulfate is modified with lithium carboxylate group. A method for preparing the composite separator and a lithium-ion battery are also provided.

### CROSS-REFERENCE TO RELATED APPLICATIONS

This application claims all benefits accruing under 35 U.S.C. §119 from China Patent Application No. 201510163908.9, filed on Apr. 9, 2015 in the State Intellectual Property Office of China, the content of which is hereby incorporated by reference. This application is a continuation under 35 U.S.C. §120 of international patent application PCT/CN2016/078395 filed on Apr. 1, 2016, the content of which is also hereby incorporated by reference.

### FIELD

The present disclosure relates to a composite separator, method for preparing the same, and lithium-ion battery for using the same.

### BACKGROUND

Gel electrolyte, also known as gel polymer electrolyte, is a complex of polymer and electrolyte liquid. The electrolyte liquid is encapsulated in a network formed by the polymer to form a gel. Lithium-ion batteries using the gel polymer electrolyte are commonly known as gel polymer batteries.

Compared to traditional liquid electrolyte, the gel polymer electrolyte has advantages, such as leakage free, high flexibility, and high physical and chemical stability. The gel polymer electrolyte also has some shortcomings, such as low mechanical strength, low ion conductivity, and the rate performance of the gel polymer battery is much lower than that of the liquid electrolyte battery. Thus, the gel polymer battery is mostly applied in batteries with low current rate. In the field of power batteries, improvement of the rate performance of the gel polymer battery is needed. In order to improve ion conductivity, ceramic nanoparticles (such as TiO₂ nanoparticles, SiO₂ nanoparticles, Al₂O₃ nanoparticles, etc.) are doped in the gel polymer electrolyte to prepare a composite gel polymer electrolyte. Because of the complex effects and large surface area of the ceramic nanoparticles, rapid ion transport channels are formed on the organic-inorganic interface in the composite gel polymer electrolyte. Thus, ion conductivity of the composite gel polymer electrolyte can be improved, and the rate performance and cycling stability of the gel polymer battery containing the composite gel polymer electrolyte can also be improved. However, due to the low Zeta potential and the high surface energy of ceramic nanoparticles, the ceramic nanoparticles aggregate easily. When aggregated, the ceramic nanoparticles do not exhibit the desirable properties as well as those exhibited by the ceramic nanoparticles individually. Experiments show that most of the commercially available inorganic nanoparticles are difficult to disperse, and even after ultrasonic treating and subsequent ball milling, high dispersion is still not achieved.

### SUMMARY

A composite separator includes a base membrane and a composite gel composited with the base membrane. The composite gel includes a gel polymer and a nano-barium sulfate dispersed in the gel polymer. A surface of the nano-barium sulfate is modified with a lithium carboxylate group.

A method for preparing the composite separator is also provided. The method comprises:

adding lithium carboxylate into a first organic solvent to form a solution, and adding the solution to a soluble barium salt aqueous solution to form a first solution;

providing a soluble sulfate aqueous solution with a pH of 8 to 10, and adding the soluble sulfate aqueous solution to the first solution to form a reaction to obtain a precipitate;

separating, water washing, and drying the precipitate to obtain a nano-barium sulfate having a surface modified with a lithium carboxylate group;

dispersing the nano-barium sulfate having the surface modified with the lithium carboxylate group in a second organic solvent to obtain a dispersing liquid;

adding a gel polymer in the dispersing liquid, and mixing the gel polymer with the dispersing liquid uniformly to obtain the composite gel; and

combining the composite gel with the base membrane.

A lithium-ion battery includes a cathode, an anode, and a gel polymer electrolyte film disposed between the cathode and anode. The gel polymer electrolyte film includes the composite separator and a non-aqueous electrolyte liquid permeated in the composite separator.

In the present disclosure, the nano-barium sulfate has a surface modified with a lithium carboxylic group. The nano-barium sulfate modified with lithium carboxylic group is easy to disperse uniformly. The nano-barium sulfate modified with lithium carboxylic group has low Zeta electric potential and low surface energy. As doping-particles, the nano-barium sulfate modified with lithium carboxylic group is easy to disperse uniformly in the gel polymer. Therefore, the lithium carboxylic group can facilitate the transportation of lithium ions to improve the ion conductivity thereby increasing the rate performance of the lithium-ion battery.

### BRIEF DESCRIPTION OF THE DRAWINGS

FIG. 1 shows a scanning electron microscope (SEM) image of Example 1 of a nano-barium sulfate.

FIG. 2 shows a SEM image of Example 4 of a composite separator.

FIG. 3 shows cycle performance curves of lithium-ion batteries of Example 4 and Comparative Example 2.

### DETAILED DESCRIPTION

A detailed description with the above drawings is made to further illustrate the present disclosure.

One embodiment of a method for preparing a composite separator is provided, and the method includes:

S1, preparing a nano-barium sulfate having a surface modified with a lithium carboxylate group;

S2, preparing a composite gel; and

S3, combining the composite gel with a base membrane to obtain the composite separator.

The step S1 further includes steps of:

S11, adding lithium carboxylate into a first organic solvent to form a solution, and adding the solution to a soluble barium salt aqueous solution to form a first solution;

S12, providing a soluble sulfate aqueous solution with a pH of 8 to 10, and adding the soluble sulfate aqueous solution to the first solution to form a reaction to obtain a precipitate;

S13, separating, water washing and drying the precipitate to obtain the nano-barium sulfate having a surface modified with the lithium carboxylate group.

In step S11, the lithium carboxylate and Ba²⁺ of the soluble barium salt can form a stable barium-lithium carboxylate complex in the first solution. The barium-lithium carboxylate complex can slowly release Ba²⁺ in a subsequent process. Therefore, barium sulfate particles do not grow too large, thereby forming the nano-barium sulfate having the surface modified with the lithium carboxylate group. Further, due to the lithium carboxylate group modified on the surface of the nano-barium sulfate in the precipitation process, the nano-barium sulfate cannot aggregate and can disperse uniformly in the subsequent process. An ionophore concentration on the surface of the nano-barium sulfate is increased to facilitate the lithium ion transportation in the composite separator.

The lithium carboxylate includes at least eight carbon atoms. The lithium carboxylate can be lithium oleate, lithium stearate, lithium dodecyl benzoate, lithium hexadecyl benzoate, or lithium polyacrylate. A mass of the lithium carboxylate can be about 1% to about 5% by mass of a theoretical mass of the nano-barium sulfate having the surface modified with the lithium carboxylate group subsequently formed.

The first organic solvent can dissolve the lithium carboxylate, and forms mesopores inside each barium sulfate particle in a subsequent process of forming the nano-barium sulfate. The first organic solvent can be a water-soluble polar organic solvent such as methanol, ethanol, isopropanol, acetone, N, N-dimethylformamide (DMP), N, N-dimethylacetamide (DMAc), or N-methylpyrrolidone (NMP). In one embodiment, the first organic solvent can be an alcohol solvent, such as ethanol, methanol or isopropanol. A volume ratio of the first organic solvent and the soluble barium salt aqueous solution can be in a range from about 1:1 to about 2:1. In one embodiment, the volume ratio of the first organic solvent and the soluble barium salt aqueous solution is about 1:1.

A concentration of the soluble barium salt aqueous solution can be in a range from about 0.1 mol/L to about 0.5 mol/L. The soluble barium salt can be barium chloride, barium nitrate, barium sulfide, or the other commonly used soluble barium salt.

In step S12, the soluble sulfate aqueous solution can be slowly added to the first solution. The barium-lithium carboxylate complex in the first solution can slowly release Ba²⁺. The Ba²⁺ and SO₄²⁻ of the soluble sulfate aqueous solution can form the nano-sized barium sulfate particles. The nano-barium sulfate is not soluble and can be obtained as the precipitate. The surface of nano-barium sulfate is modified with the lithium carboxylate group. The nano-barium sulfate includes mesopores inside each barium sulfate particle. The soluble sulfate can be sodium sulfate, potassium sulfate, ammonium sulfate, aluminum sulfate, or another commonly used soluble sulfate. A concentration of the soluble sulfate aqueous solution can be in a range from about 0.1 mol/L to about 0.5 mol/L. A molar ratio of the soluble sulfate and the soluble barium salt can be about 1:1. A pH value of the soluble sulfate aqueous solution can be adjusted in a range from about 8 to about 10 by ammonia, sodium hydroxide or potassium hydroxide.

In step S13, the precipitate can be separated from the solution by centrifugation. The precipitate separated from the solution can be washed with water about three or four times. The precipitate washed with water can be dried in a vacuum to obtain the nano-barium sulfate having the surface modified with the lithium carboxylate group. A particle size of the nano-barium sulfate can be in a range from about 30 nm to about 500 nm. A specific surface area of the nano-barium sulfate can be in a range from about 5 m²/g to about 20 m²/g. Each particle of the nano-barium sulfate contains mesopores. A pore size of the mesopores can be in a range from about 6 nm to about 10 nm.

From step S11 to step S13, a temperature in the processes can be in a range from about 15° C. to about 45° C.

In S2, a method for making the composite gel can comprise the following steps of:

S21, dispersing the nano-barium sulfate having the surface modified with the lithium carboxylate group in a second organic solvent to obtain a dispersing liquid; and

S22, adding a gel polymer in the dispersing liquid to obtain the composite gel.

In step S21, the nano-barium sulfate having the surface modified with the lithium carboxylate group can be added to the second organic solvent and then dispersed by mechanical stirring or ultrasonic vibration to obtain the dispersing liquid. The time of mechanical stirring and ultrasonic vibration depends on requirement of the dispersion, and can be in a range from about 0.5 hour to about 2 hours.

In step S22, the gel polymer can be added in the dispersing liquid step by step during stirring the dispersing liquid. To uniformly mix the gel polymer and the dispersing liquid, the stirring can be continued for a while after all the gel polymer is added to the dispersing liquid. Therefore, the nano-barium sulfate having the surface modified with the lithium carboxylate group can be uniformly dispersed in a matrix of the gel polymer to obtain the composite gel.

The nano-barium sulfate having the surface modified with the lithium carboxylate group and the gel polymer can be dispersed in the second organic solvent. The second organic solvent can be a polar organic solvent, and can be at least one of NMP, DMF, DMAc, and acetone. The gel polymer can be a gel polymer commonly used in a gel electrolyte lithium-ion batteries, such as at least one of polymethyl methacrylate (PMMA), copolymer of vinylidene fluoride and hex afluoropropylene (PVDF-HFP), polyacrylonitrile (PAN), and polyoxyethylene (PEO).

In the composite gel, a weight ratio between the nano-barium sulfate and the gel polymer can be in a range from about 2 wt % to about 30 wt %. A solid content of the composite gel=(gel polymer+nano-barium sulfate): second organic solvent=2 wt % to 15 wt %.

The step S3 can further include steps of:

S31, coating the composite gel of step S2 on the base membrane to form a composite gel layer;

S32, immersing the base membrane with the composite gel layer in a pore-forming agent, to create pores in the gel polymer; and

S33, drying the base membrane with the composite gel layer to obtain the composite separator.

In step S31, the composite gel can be applied on either or both sides of the base membrane by methods of blade coating, dip coating, extrusion coating or the like. In one embodiment, the base membrane is immersed in the composite gel, and the composite gel penetrates into the pores of the base membrane. The composite gel layer can be formed on the surfaces of the base membrane. The composite gel layer has a thickness less than 10 μm. The base membrane can be a porous polyolefin membrane. The porous polyolefin membrane can be a porous polyolefin polypropylene film, a porous polyethylene film, a porous polypropylene film, a porous polypropylene-polyethylene-polypropylene composite film. The base membrane is used to isolate electron and let lithium ion pass through pores of the base membrane. The base membrane can be a commercially available lithium-ion battery separator, such as products from Asahi, Tonen, Ube, or Celgard. In one embodiment, the base membrane is a Celgard-2325 separator.

In step S32, the pore-forming agent is a poor solvent of the gel polymer, such as water, ethanol, methanol, or combinations thereof. Therefore, the second organic solvent in the composite gel layer can be partially removed from the gel polymer to form pores. In one embodiment, the pore-forming agent can be an aqueous ethanol solution (a concentration of ethanol is in a range from about 2 wt % to 20 wt %). An immersing time can be in a range from about 0.5 hours to about 5 hours. The base membrane with the composite gel layer can be immersed in deionized water after being removed from the pore-forming agent.

In step S33, the base membrane with the composite gel layer can be dried at a temperature of about 40° C. to about 60° C. in vacuum for about 24 hours to about 48 hours to obtain the composite separator with pores.

The composite separator according to one embodiment is also provided. The composite separator includes the base membrane and the composite gel composited with the base membrane. The composite gel can be a layer structure and coated on surface of the base membrane. The base membrane includes a plurality of pores. The plurality of pores of the base membrane can be filled with the composite gel. In one embodiment, the layer of the composite gel has a thickness in a range from about 2 μm to about 10 μm.

The composite gel includes gel polymer and nano-barium sulfate dispersed in the gel polymer. A surface of the nano-barium sulfate is modified with the lithium carboxylate group. A particle size of the nano-barium sulfate having the surface modified with the lithium carboxylate group can be in a range from about 30 nm to about 500 nm. In one embodiment, the particle size of the nano-barium sulfate having a surface modified with the lithium carboxylate group can be about 30 nm to about 120 nm. The gel polymer can be a gel polymer commonly used in gel electrolyte lithium-ion batteries, such as at least one of polymethyl methacrylate (PMMA), copolymer of vinylidene fluoride and hexafluoropropylene (PVDF-HFP), polyacrylonitrile (PAN), and polyoxyethylene (PEO). The nano-barium sulfate having the surface modified with the lithium carboxylate group is uniformly dispersed in the gel polymer.

The composite gel can further include the second organic solvent which can be soluble with the gel polymer. The second organic solvent can be at least one of NMP, DMF, DMAc, and acetone. In the composite gel, a mass ratio between the nano-barium sulfate and the gel polymer can be in a range from about 2 wt % to about 30 wt %. A solid content of the composite gel=(gel polymer+nano-barium sulfate): second organic solvent=2 wt % to 15 wt %

The composite separator can be immersed in a non-aqueous electrolyte to form a gel polymer electrolyte membrane.

The nano-barium sulfate does not aggregate easily, and is easy to disperse uniformly due to the lithium carboxylate group modified on the surface of the nano-barium sulfate. Therefore, the nano-barium sulfate modified with lithium carboxylic group can be dispersed uniformly in the gel polymer to avoid segregation in the composite gel preparation process. The lithium carboxylate group modified on the surface of the nano-barium sulfate contains lithium ions which facilitate lithium ion transportation in the composite gel. A plurality of mesopores are formed inside each barium sulfate particle, and a plurality of interspaces are formed between barium sulfate particles of the nano-barium sulfate, thereby increasing the porosity of the composite separator, facilitating the penetration of the electrolyte liquid, and improving the wettability of the composite separator.

A lithium-ion battery of one embodiment is also provided. The lithium-ion battery includes a cathode, an anode, and a composite gel electrolyte film disposed between the cathode and anode. The composite gel electrolyte film includes the composite separator and a non-aqueous electrolyte liquid infiltrated in the composite separator.

The non-aqueous electrolyte liquid can include a solvent and a lithium salt dissolved in the solvent. The solvent can be selected from cyclic carbonates, chain carbonates, cyclic ethers, chain ethers, nitriles, amides, and combinations thereof, such as ethylene carbonate, propylene carbonate, diethyl carbonate, dimethyl carbonate, ethyl methyl carbonate, methyl acetate, ethyl acetate, propyl acetate, methyl propionate, ethyl propionate, diethyl ether, acetonitrile, propionitrile, anisole, butyrate, glutaronitrile, adiponitrile, γ-butyrolactone, γ-valerolactone, tetrahydrofuran, 1,2-dimethoxyethane, dimethylformamide, and combinations thereof. The lithium salt can be selected from lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium perchlorate (LiClO₄), and lithium bis-oxalate borate (LiBOB), and combinations thereof.

The cathode can further include a cathode current collector and a cathode material layer. The cathode current collector is used to support the cathode material layer and conduct electricity. A shape of the cathode current collector can be foil or mesh. A material of the cathode current collector can be selected from aluminum, titanium or stainless steel. The cathode material layer can be disposed on at least one surface of the cathode current collector. The cathode material layer can include a cathode active material. The cathode material layer optionally further includes a conductive agent and a cathode binder. The conductive agent and the cathode binder can be uniformly mixed with the cathode active material. The cathode active material can be lithium iron phosphate, spinel lithium manganese oxide, lithium cobalt oxide, or lithium nickel oxide.

The anode can include an anode current collector and an anode material layer. The anode current collector is configured to support the anode material layer and conduct electricity. A shape of the anode current collector can be foil or mesh. A material of the anode current collector can be selected from the group consisting of copper, nickel, and stainless steel thereof. The anode material layer is disposed on at least one surface of the anode current collector. The anode material layer includes an anode active material. The anode material layer further optionally includes a conductive agent and an anode binder. The conductive agent and the anode binder can be uniformly mixed with the anode active material. The anode active material can be graphite, acetylene black, mesocarbon microbeads, carbon fibers, carbon nanotubes, or pyrolysis carbon.

### Example (I) Preparation of Nano-Barium Sulfate

### Example 1

0.01 g of lithium oleate is dissolved in 50 ml of anhydrous methanol to obtain a lithium oleate solution. The lithium oleate solution is added to 50 ml, 0.5 mol/L of barium chloride solution, and homogeneously mixed for 20 minutes to 30 minutes to form the first solution. 50 ml, 0.5 mol/L of the sodium sulfate solution having a pH value of 8-9 adjusted by ammonia water is slowly added to the first solution to form the precipitate. The precipitate is separated by centrifugation, washed by water for three times, and vacuum dried in a drying oven at 80° C. to obtain the nano-barium sulfate whose surface is modified by the lithium carboxylate group.

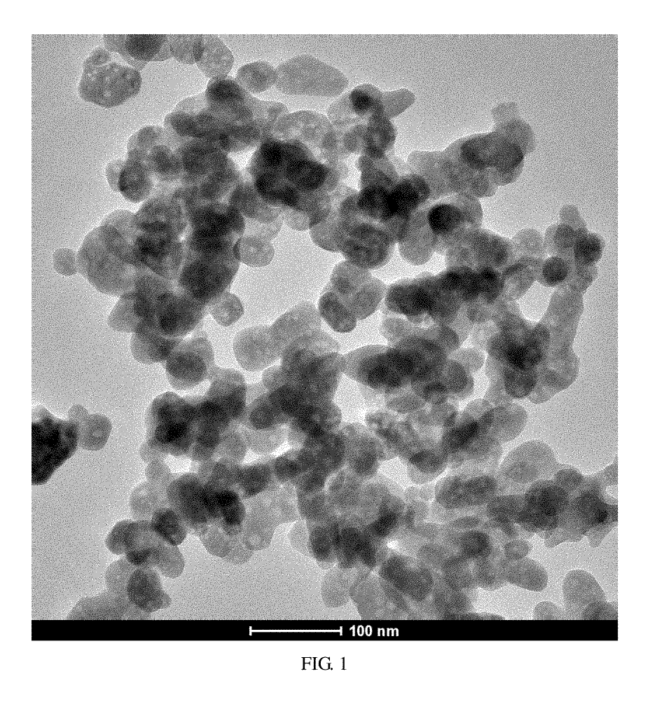

Referring to FIG. 1, a particle size of the nano-barium sulfate is small, about 30 nm to 500 nm. A plurality of interspaces is formed between the barium sulfate particles of the nano-barium sulfate. A plurality of mesopores with a pore diameter in a range from about 6 nm to about 10 nm are formed inside each barium sulfate particle. A specific surface area of the nano-barium sulfate is about 19.9 m²/g.

### Example 2

0.02 g of lithium stearate is dissolved in 100 ml of N, N-dimethylformamide to obtain a lithium stearate solution. The lithium stearate solution is added to 100 ml, 0.5 mol/L of barium chloride solution, and homogeneously mixed for 20 minutes to 30 minutes to form the first solution. 100 ml, 0.5 mol/L of potassium sulfate solution is added to the mixture solution slowly after that the pH value of the potassium sulfate solution is regulated to 8-9 by a sodium hydroxide solution. The precipitate is separated by centrifugation, washed by water three times or four times, and vacuum dried in a drying oven at 80° C. to obtain the nano-barium sulfate whose surface is modified by the lithium carboxylate group. The nano-barium sulfate has a particle size in a range from about 50 nm to about 80 nm.

### Example 3

0.03 g of lithium polyacrylate is dissolved in 150 ml of acetone to obtain lithium polyacrylate solution. The lithium stearate solution is added to 150 ml, 0.5 mol/L of barium chloride solution, and homogeneously mixed for 20 minutes to 30 minutes to form the first solution. 150 ml, 0.5 mol/L of ammonium sulfate solution is added to the mixture solution slowly after that the pH value of the ammonium sulfate solution is regulated to 8-9 by potassium hydroxide solution. The precipitate is separated by centrifugation, washed by water three times, and vacuum dried in a drying oven at 80° C. to obtain the nano-barium sulfate whose surface is modified by the lithium carboxylate group. The nano-barium sulfate has a particle size in a range from about 80 nm to about 120 nm.

### Example (II) Preparation of the Composite Separator and the Composite Gel Electrolyte Film

### Example 4

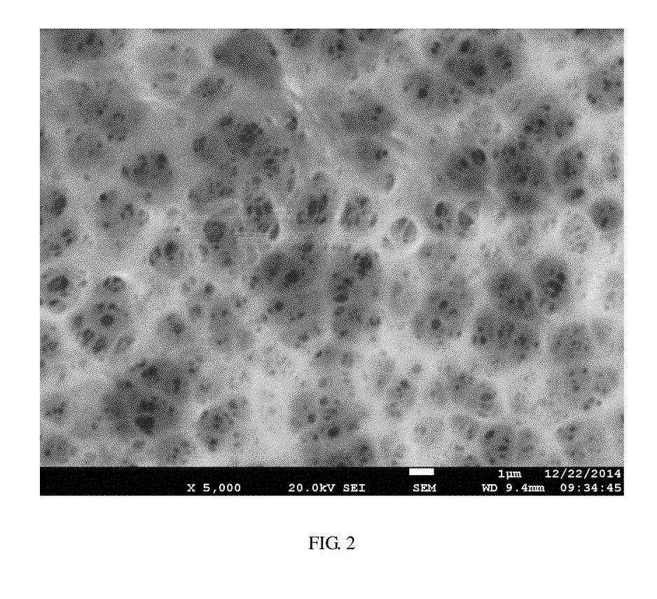

The nano-barium sulfate having the surface modified with the lithium carboxylate group prepared in Example 1 is dispersed in acetone to form a dispersing liquid. PVDF-HFP is added to the dispersing liquid to obtain a composite gel solution. A mass ratio of the nano-barium sulfate having a surface modified with the lithium carboxylate group to the PVDF-HFP is 0.2:1. In the composite gel solution, a sum content of the PVDF-HFP and the nano-barium sulfate having the surface modified with the lithium carboxylate group is 10 wt %. A polypropylene membrane is immersed in the composite gel solution for 5 minutes, and then taken out and immersed in water. After 30 minutes, the polypropylene membrane is taken out from water, and dried in an oven at 80° C. for about 24 hours to obtain a composite separator. Referring to FIG. 2, there is a plurality of micropores on surface of the composite separator, the composite gel is evenly distributed on the surface of the separator substrate, and no nano-barium sulfate aggregated particles are observed. The composite separator is immersed in an electrolyte liquid containing 1.0 M of LiPF₆ and a mixed solvent of EC and DEC in a volume ratio of 1:1. The composite separator is immersed in an electrolyte liquid for 5 minutes and adsorbs the electrolyte liquid to form the gel polymer electrolyte membrane. A thickness and a liquid absorption rate of the composite separator, and an ion conductivity of the gel polymer electrolyte film are tested. Test results are shown in Table 1.

### Example 5

The nano-barium sulfate having the surface modified with the lithium carboxylate group prepared in Example 1 is dispersed in N-methylpyrrolidone to form a dispersing liquid. PMMA is added to the dispersion liquid to obtain a composite gel solution. A mass ratio of the nano-barium sulfate having the surface modified with the lithium carboxylate group to the PMMA is 0.2:1. In the composite gel solution, a total content of the PMMA and the nano-barium sulfate having the surface modified with the lithium carboxylate group is 10 wt %. A polypropylene membrane is immersed in the composite gel solution for 5 minutes, and then taken out, and immersed in water. After 30 minutes, the polypropylene membrane is taken out from water, and dried in an oven at 80° C. for about 24 hours to obtain a composite separator. A gel polymer electrolyte film is prepared by same method as the method of Example 4. A thickness and a liquid absorption rate of the composite separator, and an ionic conductivity of the gel polymer electrolyte film are tested. Test results are shown in Table 1.

### Example 6

The nano-barium sulfate having a surface modified with the lithium carboxylate group prepared in Example 1 is dispersed in N, N-dimethylformamide to form a dispersing liquid. PAN is added to the dispersion liquid to obtain a composite gel solution. A mass ratio of the nano-barium sulfate having the surface modified with the lithium carboxylate group to the PAN is 0.2:1. In the composite gel solution, a total content of the PAN and the nano-barium sulfate having a surface modified with the lithium carboxylate group is 10 wt %. A polypropylene membrane is immersed in the composite gel solution for 5 minutes, and then taken out and immersed in water. After 30 minutes, the polypropylene membrane is taken out from water, and dried in an oven at 80° C. for about 24 hours to obtain a composite separator. A gel polymer electrolyte film is prepared by same method as the method of Example 4. A thickness and a liquid absorption rate of the composite separator, and an ionic conductivity of the gel polymer electrolyte film are tested. Test results are shown in Table 1.

### Comparative Example 1

PVDF-HFP is dispersed in acetone to form a PVDF-HFP gel solution. In the PVDF-HFP gel solution, a total content of the PVDF-HFP is 10 wt %. A polypropylene membrane is immersed in the PVDF-HFP gel solution for 5 minutes, and then taken out and immersed in water. After 30 minutes, the polypropylene membrane is taken out from water, and dried in an oven at 80° C. for about 24 hours to obtain a composite separator. A gel polymer electrolyte film is prepared by same method as the method of Example 4. A thickness and a liquid absorption rate of the composite separator, and an ionic conductivity of the gel polymer electrolyte film are tested. Test results are shown in Table 1.

### Comparative Example 2

Commercial nano-barium sulfate is dispersed in acetone to form a dispersing liquid. PVDF-HFP is added to the dispersing liquid to obtain a composite gel solution. A mass ratio of the commercial nano-barium sulfate to the PVDF-HFP is 0.2:1. In the composite gel solution, a total content of the PVDF-HFP and the commercial nano-barium sulfate is 10 wt %. A polypropylene membrane is immersed in the composite gel solution for 5 minutes, and then taken out and immersed in water. After 30 minutes, the polypropylene membrane is taken out from water, and dried in an oven at 80° C. for about 24 hours to obtain a composite separator. A gel polymer electrolyte film is prepared by the same method as the method of Example 4. A thickness and a liquid absorption rate of the composite separator, and an ionic conductivity of the gel polymer electrolyte film are tested. Test results are shown in Table 1.

TABLE 1

| | Comparative | Comparative | Exam- | Exam- | Exam- |
|---|---|---|---|---|---|
| | Example 1 | Example 2 | ple 4 | ple 5 | ple 6 |
| Composite | 30 | 31 | 31 | 33 | 36 |
| separator | | | | | |
| thickness (μm) | | | | | |
| Liquid | 180 wt | 200 wt | 250 wt | 240 wt | 250 wt |
| absorption rate | % | % | % | % | % |
| Ionic | 0.36 | 0.41 | 0.52 | 0.54 | 0.68 |
| conductivity | | | | | |
| (mS/cm) | | | | | |

When the liquid absorption rate is measured, the composite separator is immersed in an electrolytic solution for 12 hours. After taken out from the electrolytic solution, liquid on surface of the composite separator is sucked by a water-absorbing paper. A mass W₀ before immersing, and a mass W₁ after immersion of the composite separator are measured. The liquid absorption rate of the composite separator is (W₁−W₀)/W₀. As can be seen from the above experimental data, the liquid absorption rate and the ionic conductivity of the composite separators of Examples 4 to 6 are significantly improved relative to Comparative Examples 1 and 2. Because the nano-barium sulfate added to the gel polymer is easy to absorb liquid due to its high specific surface area, and the nano-barium sulfate can also help the gel polymer with high porosity, so the liquid absorption rate of the composite separator is increased. The commercial nano-barium sulfate used in Comparative Example 3 is easy to aggregate, and cannot disperse uniformly in the gel polymer, so the commercial nano-barium sulfate cannot take full advantage of high specific surface area to improve the liquid absorption and ion conductivity. Therefore, the effect of improving the liquid absorption and ionic conductivity of the composite separator is not obvious in Comparative Example 2. In addition, the nano-barium sulfate having the surface modified with the lithium carboxylate group used in Examples 4 to 6 has mesopores, which also helps the absorption rate of the composite separator.

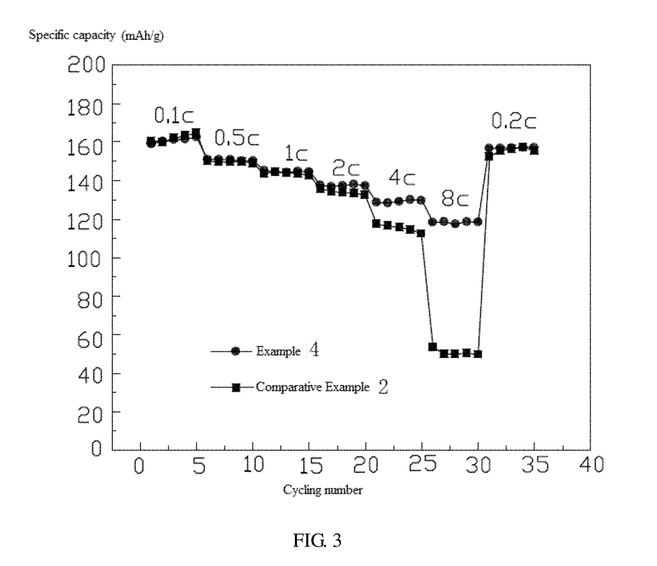

Referring to FIG. 3, the composite separators of Example 4, and Comparative Example 2 are respectively assembled in lithium-ion batteries. The other components of the lithium-ion batteries are the same. The rate performances of the lithium-ion batteries are tested at rates of 0.1 C, 0.5 C, 1 C, 2 C, 4 C, 8 C. Specifically, the lithium ion batteries are in turn charged at 0.1 C and discharged at 0.1 C for five times, charged at 0.2 C and discharged at 0.1 C for five times, charged at 0.2 C and discharged at 1 C for five times, charged at 0.2 C and discharged at 2 C for five times, charged at 0.2 C and discharged at 5 C for five times, and charged at 0.2 C and discharged at 8 C for five times with 2.8V-4.3V of cut-off voltage. It can be seen from cycling results that the discharge capacity of the lithium ion battery of Example 4 decreases little as discharge rates increases, and has a better rate performance.

In the present disclosure, the nano-barium sulfate whose surface is modified with the lithium carboxylate group with high dispersibility is prepared. Due to the lithium carboxylate group, the nano-barium sulfate does not aggregate easy and can disperse uniformly to the gel polymer, the Zeta potential of the nano-barium sulfate is changed, the surface energy of the nano-barium sulfate is decreased, and ionophore concentration on the surface of the nano-barium sulfate is increased. As doping-particles mix with the gel polymer, the nano-barium sulfate can disperse uniformly to the gel polymer to obtain the composite gel. The lithium carboxylate group can facilitate the lithium ion transport and increase the ion conductivity, thereby improving the rate performance of the lithium ion battery.

Other embodiments of the disclosure will be apparent to those skilled in the art from consideration of the specification and practice of the embodiments disclosed herein. It is intended that the specification and examples be considered as exemplary only, with the true scope and spirit of the embodiments being indicated by the following claims.

What is claimed is:

1. A composite separator, comprising:
a base membrane; and
a composite gel composited with the base membrane, the composite gel comprising a gel polymer and a nano-barium sulfate dispersed in the gel polymer, and a surface of the nano-barium sulfate being modified with a lithium carboxylate group.

2. The composite separator of claim 1, wherein the lithium carboxylate group comprises at least eight carbon atoms.

3. The composite separator of claim 1, wherein the nano-barium sulfate comprises a plurality of barium sulfate particles, and a plurality of mesopores are formed inside each barium sulfate particle of the nano-barium sulfate.

4. The composite separator of claim 1, wherein the composite gel forms a layer structure on a surface of the base membrane.

5. The composite separator of claim 4, wherein a thickness of the layer structure is in a range from about 2 μm to about 10 μm.

6. The composite separator of claim 1, wherein a particle size of the nano-barium sulfate is in a range from about 30 nm to about 500 nm.

7. The composite separator of claim 1, wherein the gel polymer is selected from the group consisting of polymethyl methacrylate, copolymer of vinylidene fluoride and hexafluoropropylene, polyacrylonitrile, and polyoxyethylene, and combinations thereof.

8. The composite separator of claim 1, wherein a mass ratio between the nano-barium sulfate and the gel polymer is in a range from about 2:100 to about 30:100.

9. A method for preparing a composite separator, comprising:
adding lithium carboxylate into a first organic solvent to form a solution, and mixing the solution to a soluble barium salt aqueous solution to form a first solution;
providing a soluble sulfate aqueous solution with a pH value of 8 to 10, adding the soluble sulfate aqueous solution to the first solution to form a reaction to obtain a precipitate;
separating, water washing, and drying the precipitate to obtain a nano-barium sulfate having a surface modified with a lithium carboxylate group;
dispersing the nano-barium sulfate having the surface modified with the lithium carboxylate group in a second organic solvent to obtain a dispersing liquid;
adding the gel polymer in the dispersing liquid to obtain the composite gel; and
combining the composite gel with a base membrane.

10. The method of claim 9, wherein the first organic solvent is a water-soluble polar organic solvent, and a volume ratio of the water-soluble polar organic solvent and the soluble barium salt aqueous solution is in a range from about 1:1 to about 2:1.

11. The method of claim 9, wherein the lithium carboxylate is selected from the group consisting of lithium oleate, lithium stearate, lithium benzoate dodecyl, hexadecyl lithium benzoate, lithium polyacrylate, and combinations thereof.

12. The method of claim 11, wherein a mass of the lithium carboxylate is in a range from about 1% to about 5% of a mass of the nano-barium sulfate.

13. The method of claim 9, wherein the combining the composite gel with the base membrane comprising:
coating the composite gel on the base membrane to form a composite gel layer;
immersing the base membrane with the composite gel layer in a pore-forming agent, to create pores in the composite gel layer; and
drying the base membrane with the composite gel layer to obtain the composite separator.

14. A lithium-ion battery, comprising:
a cathode;
an anode; and
a composite gel electrolyte film disposed between the cathode and the anode, the composite gel electrolyte film comprising a composite separator and a non-aqueous electrolyte liquid permeated in the composite separator, the composite separator comprising:
a base membrane; and
a composite gel composited with the base membrane, the composite gel comprising a gel polymer and a nano-barium sulfate dispersed in the gel polymer, and a surface of the nano-barium sulfate being modified with a lithium carboxylate group.
